(19) United States
(12) Patent Application Publication
(10) Pub. No.: US 2023/0015179 A1
(43) Pub. Date: Jan. 19, 2023

(54) ANODE ACTIVE MATERIAL FOR LITHIUM-ION BATTERY AND METHOD FOR MAKING THE SAME, AND LITHIUM-ION BATTERY USING THE SAME

(71) Applicants: Tsinghua University, Beijing (CN); HON HAI PRECISION INDUSTRY CO., LTD., New Taipei (TW)

(72) Inventors: ZHEN-HAN FANG, Beijing (CN); JIA-PING WANG, Beijing (CN); SHOU-SHAN FAN, Beijing (CN)

(21) Appl. No.: 17/504,916

(22) Filed: Oct. 19, 2021

(30) Foreign Application Priority Data
Jul. 14, 2021 (CN) 202110794392.3

(51) Int. Cl. H01M 4/36; H01M 4/38; H01M 4/62; H01M 10/0525; H01M 4/134; H01M 4/1395

(52) U.S. Cl. CPC H01M 4/366; H01M 4/38; H01M 4/625; H01M 10/0525; H01M 4/134; H01M 4/1395; H01M 2004/021

(57) ABSTRACT

An anode active material for lithium-ion battery is provided. The anode active material includes a composite material comprising a binary or multi-element metal alloy and a conductive material. The binary or multi-element metal alloy is granular, a particle size of a binary or multi-element metal alloy particle is in micron-sized, and the binary or multi-element metal alloy has lattice reversibility. The conductive material is coated on a surface of a binary or multi-element metal alloy particle. The binary or multi-element metal alloy particle is completely wrapped by the conductive material. A method of making the anode active material is also provided. A lithium-ion battery using the anode active material is also provided.

### CROSS-REFERENCE TO RELATED APPLICATIONS

This application claims all benefits accruing under 35 U.S.C. § 119 from China Patent Application No. 202110794392.3, filed on Jul. 14, 2021, in the China Intellectual Property Office, the contents of which are hereby incorporated by reference.

### FIELD

The present disclosure relates to lithium-ion battery field, especially relates to an anode active material and a method for making the same; and also relates to a lithium-ion battery using the anode active material.

### BACKGROUND

A lithium storage mechanism of anode materials for lithium-ion batteries can be divided into the following three types. One type is a deintercalation mechanism of lithium-ions in materials with lithium vacancies, a cycle stability of the deintercalation mechanism is excellent, however, a capacity is low. One type is a lithium reversible redox mechanism represented by oxides, nitrides and sulfides. Although the lithium reversible redox mechanism has a high capacity, a working potential of the lithium reversible redox mechanism is also high, which leads to a decrease in battery output voltage. Further, reaction kinetics of the lithium reversible redox mechanism is slow, therefore, the lithium reversible redox mechanism is difficult to meet the energy supply requirements of electronic devices. Another type is a mechanism of storing lithium-ions through alloy reaction, the mechanism has extremely high capacity and low working potential, therefore, the energy density of the battery can be improved while ensuring safety. The mechanism of storing lithium-ions through alloy reaction is an ideal choice for flexible electronics.

In lithium-ion batteries using the mechanism of storing lithium-ions through alloy reaction, a metal element and a binary or multi-element alloy are usually used as anode active materials for the lithium-ion batteries. However, when the metal element is used as the anode active material for lithium-ion battery, as the alloy reaction progresses, the active material has a huge volume change after lithium insertion. The huge volume change causes pulverization and shedding of the active materials, the active materials detach from a current collector and causes irreversible capacity loss; and a solid electrolyte interface (SEI) is destroyed and a fresh active material is exposed, which intensifies a consumption of an electrolyte. Compared to the metal element, the binary or multi-element alloy has larger initial lattice volume; therefore, using the binary or multi-element alloy as the anode active material of lithium-ion batteries has a smaller volume expansion than that of using the metal element as the anode active material of lithium-ion batteries.

However, for the mechanism of storing lithium-ions through alloy reaction, there are still many problems when using the binary or multi-element alloy as the anode active material of lithium-ion batteries. For example, during a lithium-ion cycle, as a lithium intercalation reaction proceeds, a plurality of whisker-like substances are gradually formed on a surface of the binary or multi-element alloy. The whisker-like substances destroy the solid electrolyte interface (SEI) that initially grows on the surface of the binary or multi-element alloy; therefore, the whisker-like substances can contact fresh electrolyte and the SEI is produced again, which causes the electrolyte consumption. Furthermore, the whisker-like substances may break or fall off during a process of inserting and releasing lithium, and an irreversible capacity is generated, and thereby causing the anode active material of lithium-ion battery cannot reach a fully lithiated state. The whisker-like substances also lead to larger volume expansion rate and area expansion rate.

### BRIEF DESCRIPTION OF THE DRAWINGS

Implementations of the present technology will now be described, by way of example only, with reference to the attached figures, wherein:

FIG. 1 is a scanning electron microscope photograph of one embodiment of an indium antimonide (InSb) alloy.

FIG. 2 is a schematic diagram of a crystal structure change of the InSb alloy of one embodiment during a charging and discharging process of a lithium-ion battery.

FIG. 3 is a comparison chart of XRD spectrum lines before and after a InSb alloy surface is coated with a carbon layer.

FIG. 4 is a scanning electron micrograph of one embodiment of a composite material bInSb@C formed by the InSb alloy and a carbon layer coated on the InSb alloy.

FIG. 5 is a transmission electron micrograph of the composite material bInSb@C in FIG. 4.

FIG. 6 is a performance comparison chart of button half cells with different mass ratios of InSb after ball milling and sucrose.

FIG. 7 is a schematic structural diagram of one embodiment of a lithium-ion battery anode.

FIG. 8 is a flowchart of a method for preparing a lithium-ion battery anode of one embodiment.

FIG. 9 is a cycle performance diagram of one embodiment of three button half-cells assembled with three anodes pInSb@CNT, bInSb@CNT and bInSb@C@CNT.

FIG. 10A is an electron microscope photograph of bInSb of the button half-cells in FIG. 9 during cycling.

FIG. 10B is an electron microscope photograph of bInSb@C of the button half-cells in FIG. 9 during cycling.

FIG. 11A is an initial impedance spectra of the button half-cell in FIG. 9 with anode pInSb@CNT, and an impedance spectra of the button half-cell after cycling 1 time and 100 times at a rate of 0.2 C.

FIG. 11B is an initial impedance spectra of the button half-cell with anode pInSb@CNT in FIG. 9, and an impedance spectra of the button half-cells after cycling 1 time and 100 times at a rate of 0.2 C.

FIG. 11C is an initial impedance spectra of the button half-cell with anode bInSb@C@CNT in FIG. 9, and an impedance spectra of the button half-cells after cycling 1 time and 100 times at a rate of 0.2 C.

FIG. 12A is an electron micrograph of the button half-cell in FIG. 9 with anode pInSb@CNT before cycling.

FIG. 12B is an electron micrograph of the button half-cell in FIG. 9 with anode pInSb@CNT during a first cycling.

FIG. 12C is an electron micrograph of the button half-cell in FIG. 9 with anode pInSb@CNT during the 100th cycling.

FIG. 12D is an electron micrograph of the button half-cell in FIG. 9 with anode bInSb@CNT before cycling.

FIG. 12E is an electron micrograph of the button half-cell in FIG. 9 with anode bInSb@CNT during a first cycling.

FIG. 12F is an electron micrograph of the button half-cell in FIG. 9 with anode bInSb@CNT during the 100th cycling.

FIG. 12G is an electron micrograph of the button half-cell in FIG. 9 with anode bInSb@C@CNT before cycling.

FIG. 12H is an electron micrograph of the button half-cell in FIG. 9 with anode bInSb@C@CNT during a first cycling.

FIG. 12I is an electron micrograph of the button half-cell in FIG. 9 with anode bInSb@C@CNT during the 100th cycling.

FIG. 13 is GITT test results of the three button half-cells in FIG. 9.

FIG. 14 is a graph showing a rate characteristic of the three button half-cells in FIG. 9.

FIG. 15 is a long-cycle performance curve of the three button half-cells in FIG. 9 at a current density of 1 C.

FIG. 16 is a long-cycle performance curve of the button half-cell assembled by bInSb@C@CNT in FIG. 9 at 3 C current density.

FIG. 17 is a schematic structural diagram of a flexible full battery of one embodiment.

FIG. 18 is a cycle performance curve of the flexible full battery in FIG. 17 at a current density of 0.2 C.

FIG. 19 is an initial cycle voltage-capacity curve of the flexible full battery in FIG. 17 under three bending angles.

FIG. 20 is an initial area specific capacity and an area specific capacity of the 100th cycle of the flexible full battery in FIG. 17 under three bending conditions.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to illustrate details and features of the present disclosure better.

Several definitions that apply throughout this disclosure will now be presented.

The term “substantially” is defined to be essentially conforming to the particular dimension, shape, or other feature which is described, such that the component need not be exactly or strictly conforming to such a feature. The term “comprise,” when utilized, means “include, but not necessarily limited to”; it specifically indicates open-ended inclusion or membership in the so-described combination, group, series, and the like. The term “binary or multi-element metal alloy” in the present disclosure means “binary metal alloy or multi-element metal alloy”.

One embodiment is described in relation to an anode active material for lithium-ion battery. The anode active material comprises a composite material. The composite material is formed by a binary or multi-element metal alloy and a conductive material. The binary or multi-element metal alloy is granular. The conductive material is coated on a surface of a binary or multi-element metal alloy particle to form a continuous conductive material layer, and the binary or multi-element metal alloy particle is completely wrapped by the conductive material. A particle size of the binary or multi-element metal alloy particle is in micron-sized.

The binary or multi-element metal alloy can be formed by at least two metal elements among Zn, Al, Ga, In, Ge, Sn, Sb, Bi, Ag, Au, Mg, and Ca. The binary or multi-element metal alloy has lattice reversibility, that is, a crystal lattice of the binary or multi-element metal alloy is reversible. The “lattice reversibility” means that when lithium-ions are inserted, a metal element in the binary or multi-element metal alloy is replaced; and when the lithium-ions are released, the replaced metal element in the substituted binary or multi-element metal alloy can re-enter into an unsubstituted metal lattice to re-form the binary or multi-element metal alloy. The “lattice reversibility” makes the lithium-ions more stable and reversible during the cycle.

The binary or multi-element metal alloy has a crystal structure with a reversibility of lithium-ion deintercalation. For example, the binary or multi-element metal alloy has a zinc blende crystal structure.

The particle size of the binary or multi-element metal alloy particle is in micron-sized. In one embodiment, the particle size of the binary or multi-element metal alloy particle is in a range from 1 micrometer to 10 micrometers. The particle size range can make the anode active material fully contact with the electron and ion conductive network of the cathode; thereby improving the utilization rate and rate performance of the anode active materials, and does not affect a consumption of electrolyte as much as possible. In one embodiment, the particle size of the binary or multi-element metal alloy particle is greater than or equal to 2 micrometer and less than or equal to 5 micrometers.

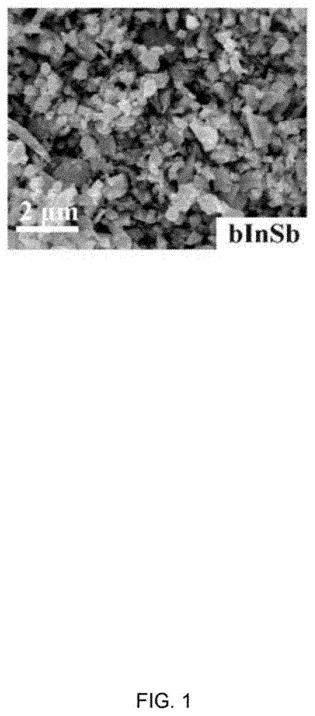

In one embodiment, the anode active material is a composite material formed by a binary metal alloy and a conductive material, the binary metal alloy is an indium antimonide (InSb) alloy with the zinc blende crystal structure, and a particle size of a InSb alloy particle is 2 micrometers. FIG. 1 is a scanning electron micrograph of the InSb alloy in one embodiment, it can be seen from FIG. 1 that the particle size of the InSb alloy particle is uniform, and the particle size is about 2 micrometers.

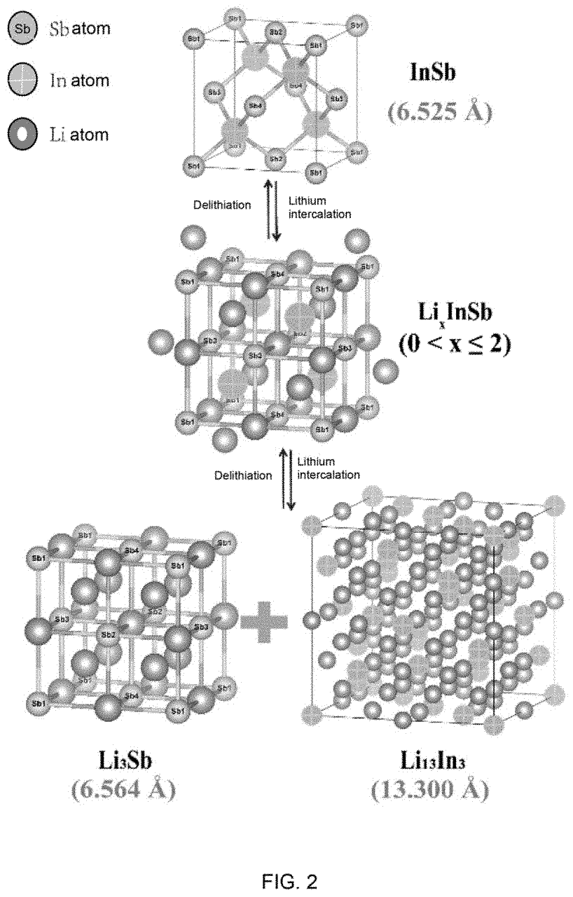

Referring to FIG. 2, in a process of lithium insertion, lithium-ions insert into the vacancies of the InSb lattice first, until a metastable state of Li₂InSb is formed. Furthermore, indium (In) atoms in Li₂InSb are replaced by the lithium-ions, and Li₃Sb particles are gradually formed; and the indium atoms replaced by the lithium-ions accumulate on a surface of Li₃Sb particles. At this time, Li₃Sb can not store more lithium-ions, so in the subsequent lithium insertion process only indium (In) participates in the alloy until Li₁₃In₃ is formed. A process of removing lithium is completely reversible compared to the process of inserting lithium. First, Li₁₃In₃ gradually de-lithium and becomes In, then as the Li in Li₃Sb escapes, the In atoms return to the lattice of Sb and return to InSb. FIG. 2 shows that the lattice structure of InSb is completely reversible during the cycle of lithium-ion batteries, therefore, the cycle stability and reversibility of the lithium-ion batteries can be greatly improved.

Since the conductive material is coated on the surface of the binary or multi-element metal alloy particles, the growth, cracking and shedding of whisker-like substances on the surface of binary or multi-element metal alloy particles during the lithium-ion cycle are restricted. The SEI originally grown on the surface of binary or multi-element metal alloy particles can not be destroyed by the whisker-like substances, to avoid the whisker-like substances being contact with fresh electrolyte to produce SEI again. Therefore, the electrolyte consumption and irreversible capacity are avoided, and the cycle stability of lithium-ion batteries is further improved. Moreover, the volume and area expansion of the anode of the lithium-ion battery can be restricted by restricting the growth of the whisker-like substances, and the volume expansion rate and the area expansion rate can be reduced. The conductive material can be carbon materials such as graphene, carbon nanotubes, and amorphous carbon, or conductive polymers.

The conductive material is coated on the surface of the binary or multi-element metal alloy particle to form the continuous conductive material layer. A thickness of the conductive material layer ranges from 10 to 50 nanometers. The thickness of the conductive material layer can not be too large, if the thickness of the conductive material layer is too large, such as greater than 50 nanometers, the lithium-ions in the electrolyte cannot enter the binary or multi-element metal alloy; the ion transmission is difficult and the capacity at high rate is low. The thickness of the conductive material layer can not be too small, if the thickness of the conductive material layer is too small, such as smaller than 10 nanometers, the conductive material layer is discontinuous and cannot completely cover the binary or multi-element metal alloy, and thus the cracking and shedding of whisker-like substances on the surface of the binary or multi-element metal alloy cannot be well limited.

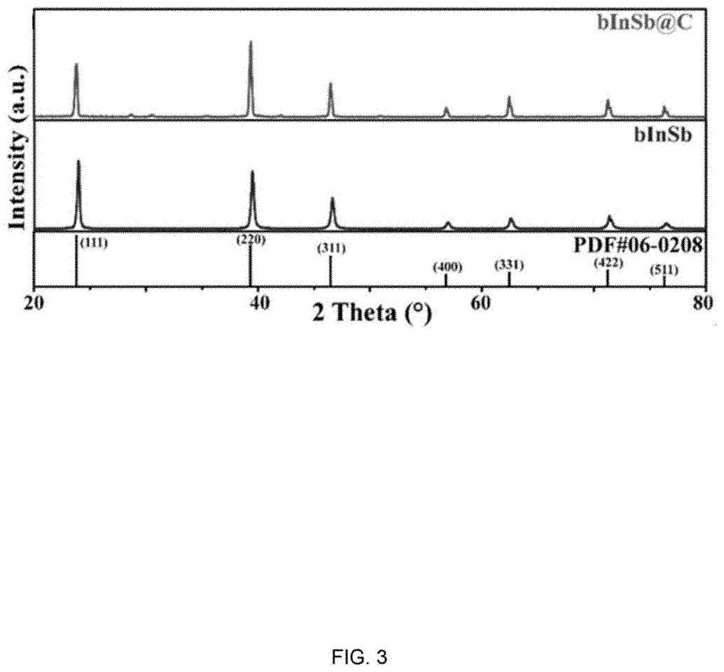

In one embodiment, the conductive material is an amorphous carbon, and a thickness of an amorphous carbon layer is 20 nanometers. Referring to FIG. 3, it can be seen that from FIG. 3 after the surface of the InSb particle being coated by the amorphous carbon layer, an Xrd spectral line still meets a standard peak of InSb, which shows that coating the amorphous carbon layer on the surface of InSb does not cause a change of the crystal structure of InSb and an introduction of other impurities.

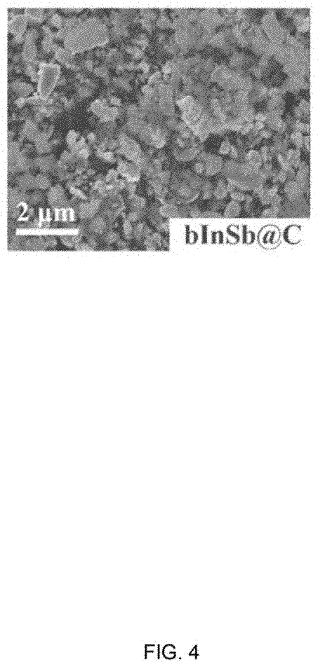

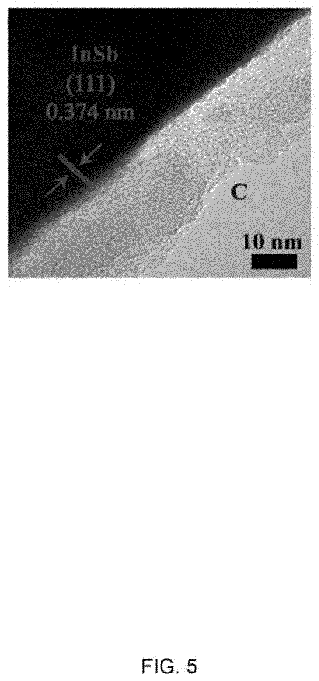

Referring to FIG. 4 and FIG. 5, it can be seen from FIG. 4 and FIG. 5 that the InSb@C particles are uniform in size, and the amorphous carbon layer with a thickness of about 20 nm is evenly coated on the surface of the InSb particles.

A method for making the anode active material for lithium-ion battery is provided, the method comprises the following steps:
step S1, providing an initial binary or multi-element metal alloy, ball milling the initial binary or multi-element metal alloy to obtain a plurality of binary or multi-element metal alloy particles, and a particle size of each of the plurality of binary or multi-element metal alloy particles is in micron-sized; and

step S2, coating a conductive material on a surface of each of the plurality of binary or multi-element metal alloy particles, and the binary or multi-element metal alloy particles are completely wrapped by the conductive material.

In step S1, the initial binary or multi-element metal alloy refers to the binary or multi-element metal alloy before ball milling. The initial binary or multi-element metal alloy can be directly purchased binary or multi-element metal alloy powder. A particle size of each binary or multi-element metal alloy particle in the initial binary or multi-element metal alloy is large, and the ball milling is to reduce the particle size of the binary or multi-element metal alloy particle and make the particle size of the plurality of binary or multi-element metal alloys uniform. A particle size of the binary or multi-element metal alloy particle after ball milling is in a range from 1 micrometer to 10 micrometers. The particle size range can make the anode active material fully contact with the electron and ion conductive network of the cathode, thereby improving the utilization rate and rate performance of the anode active materials; and does not affect a consumption of electrolyte as much as possible.

A method of ball milling the initial binary or multi-element metal alloy comprises: dispersing the initial binary or multi-element metal alloy in an organic solvent, and ball milling the initial binary or multi-element metal alloy in a ball mill at a speed of 300-600 r/min for 10-15 hours; and then recovering a powder by centrifugation, and grinding the powder with a mortar for 8-15 minutes to obtain the plurality of binary or multi-element metal alloy particles in micron-sized.

In step S2, a method of coating the conductive material on the surface of each of the plurality of binary or multi-element metal alloy particles can be selected according to the conductive material. For example, chemical vapor deposition, electroplating, vacuum evaporation, magnetron sputtering, molecular beam epitaxy, molecular (atomic) layer deposition, and liquid coating.

In one embodiment, the binary or multi-element metal alloy is InSb. Since a melting point of InSb is 525 degrees Celsius, it is difficult to be coated by the conductive materials using chemical vapor deposition and other methods. In one embodiment, the conductive material is coated on the InSb by a liquid coating method using a sucrose solution with lower pyrolysis temperature. Specifically, mixing the InSb after ball milling and sucrose in a mass ratio of 1:1 to 1:3 to obtain a mixture; adding deionized water into the mixture and performing ultrasonic treatment to form a dispersion; and then drying all moisture of the dispersion at 80-100° C., to obtain a InSb precursor coated with sucrose; and finally, heating the InSb precursor to 400-500° C. under argon atmosphere and keeping for 2-3 h, to obtain InSb@C powder.

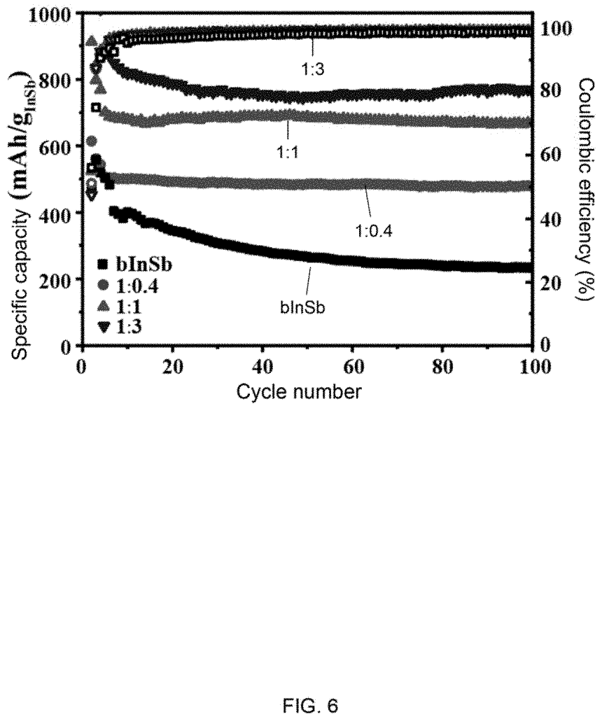

Referring to FIG. 6, the InSb after ball milling is defined as bInSb, a first material is prepared by a mass ratio of bInSb to sucrose being 1:0.4, a second material is prepared by the mass ratio of bInSb to sucrose being 1:1, and a third material is prepared by the mass ratio of bInSb to sucrose being 1:3. The first material, the second material, the third material and the bInSb are respectively combined with a carbon nanotube film to prepare four different electrodes, and the four different electrodes are respectively assembled with lithium foil to form four button half-cells. The four button half-cells are activated for 5 cycles at a rate of 0.1 C, and then cycled at a rate of 0.2 C. It can be seen that as the carbon content increases, a specific cycle capacity of the button half-cells also increases; however, for the second material of 1:1 and the third material of 1:3, an effect of increasing carbon content on capacity improvement is weakened. Therefore, considering that the carbon content needs to be as low as possible to increase the energy density, the mass ratio of bInSb to sucrose being 1:1 is a best ratio. In one embodiment, mixing the InSb after ball milling and sucrose in the mass ratio of 1:1 to obtain the mixture.

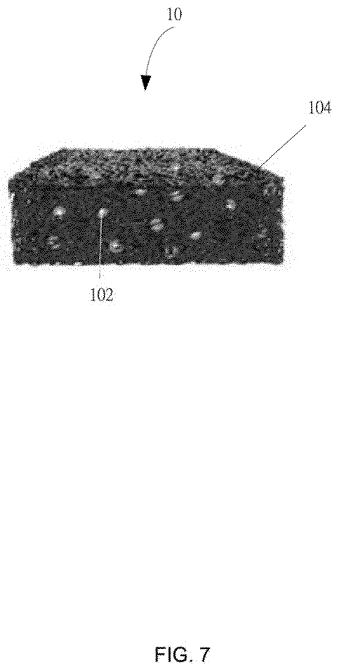

Referring to FIG. 7, one embodiment is described in relation to a lithium-ion battery anode 10. The lithium-ion battery anode 10 comprises an anode active material 102 and a current collector 104. The anode active material 102 is supported on a surface and/or inside of the current collector 104. The anode active material 102 is the anode active material for lithium-ion battery described as above embodiment. The anode active material 102 comprises a composite material. The composite material is formed by a binary or multi-element metal alloy and a conductive material. The binary or multi-element metal alloy is granular. The conductive material is coated on a surface of a binary or multi-element metal alloy particle to form a continuous conductive material layer, and the binary or multi-element metal alloy particle is completely wrapped by the conductive material. A particle size of the binary or multi-element metal alloy particle is in micron-sized.

The current collector 104 is used to carry the anode active material 102. The current collector 104 can be a conventional lithium-ion battery anode current collector. In one embodiment, the current collector 104 is a carbon nanotube paper. Carbon nanotubes have excellent flexibility, so that the carbon nanotube paper can still contact with the anode active material well under various deformations. Compared with metal current collectors such as copper foil, the carbon nanotube paper is lighter in weight, and does not need to add additional conductive agents and binders, which can greatly reduce a proportion of inactive materials in the electrode. The carbon nanotube paper comprises a plurality of grids intertwined with each other, and the anode active material 102 is supported in the plurality of grids. The plurality of grids intertwined with each other can provide a complete electronic network and sufficient ion transmission channels, and can also chain the anode active material 102; therefore, when the volume change causes the pulverization and shedding of the anode active material 102, the anode active material 102 can be in contact with the current collector 104 to a greatest extent. In the lithium-ion battery anode 10, if the content of carbon nanotube is too small, such as smaller than 20%, a stable and complete electronic network cannot be provided, and the film formation and flexibility of the lithium-ion battery anode are also greatly affected; if the content of carbon nanotube is too great, such as greater than 30%, the overall energy density of lithium-ion battery electrode is reduced, and the consumption of electrolyte is also increased due to the increased surface area. In one embodiment, in the lithium-ion battery anode 10, the mass proportion of the carbon nanotube paper is 20-30%, and the mass proportion of the anode active material 102 is 70%-80%. In one embodiment, in the lithium-ion battery anode 10, the current collector 104 is the carbon nanotube paper, and the lithium-ion anode material is InSb@C. The lithium-ion battery anode in this embodiment is defined as InSb@C@CNT, in the lithium-ion battery anode InSb@C@CNT, the mass proportion of the carbon nanotube paper is 25%, and the mass proportion of the InSb@C is 75%.

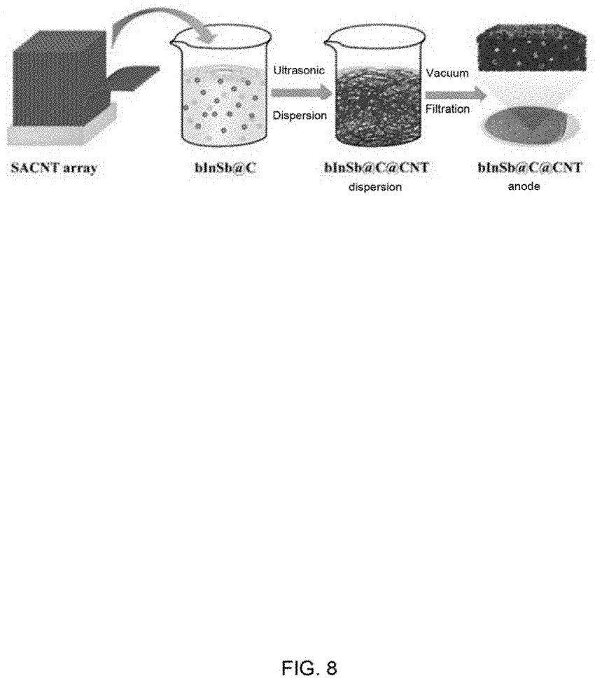

Referring to FIG. 8, a method of making the lithium-ion battery anode 10 comprises:

Step T1, adding the anode active material 102 and a super-aligned carbon nanotube array to an organic solvent, and ultrasonically dispersing to obtain a dispersion;

Step T2, vacuum filtrating the dispersion using an organic filter membrane to obtain a membrane;

Step T3, drying the organic solvent in the membrane to obtain a carbon nanotube paper carrying the anode active material; and

Step T4, cutting the carbon nanotube paper carrying the anode active material to obtain the lithium-ion battery anode.

The initial InSb is defined as pInSb, the InSb after ball milling is defined as bInSb, and a composite material of the bInSb coated with a carbon layer is defined as bInSb@C. Three lithium-ion battery anodes pInSb@CNT, bInSb@CNT and bInSb@C@CNT are prepared using pInSb, bInSb and bInSb@C as the active materials respectively, and the carbon nanotube paper as the current collector. The three lithium-ion battery anodes pInSb@CNT, bInSb@CNT and bInSb@C@CNT are respectively used as a positive electrode, a polypropylene film is used as separator, a lithium foil is used as a negative electrode, a solution formed by adding 1 mol/L lithium hexafluorophosphate (LiPF6) to a non-aqueous solvent of fluoroethylene carbonate (FEC), fluoromethyl ethyl carbonate (FEMC) and (HFE) with a mass ratio of 2:6:2 is used as an electrolyte, stainless steel gaskets and springs are also used, and a CR2025 battery shell is used to assemble three button half-cells. The assembly process of the three button half-cells is carried out in an argon glove box.

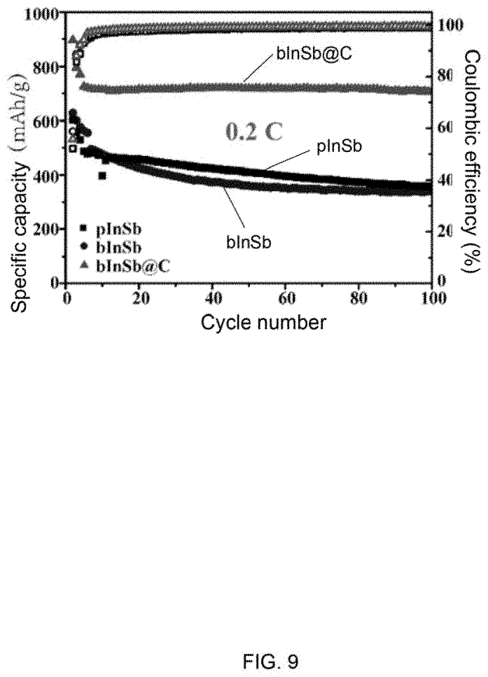

Referring to FIG. 9, the three button half-cells are activated by cycling 3 times at a current density of 0.1 C, and then performing subsequent cycles at a current density of 0.2 C. It can be seen from FIG. 9 that at a current density of 0.2 C, the three button half-cells assembled by pInSb@CNT anode, bInSb@CNT anode and bInSb@C@CNT anode exhibits initial capacities of 528.0 mAh g⁻¹, 554.5 mAh g⁻¹ and 725.7 mAh g⁻¹, respectively. After 100 cycles, the capacity retention rates of the three button half-cells assembled by pInSb@CNT anode, bInSb@CNT anode and bInSb@C@CNT anode are 67.5%, 61.4% and 97.1%, respectively. It can also be seen that in the button half-cell assembled by the bInSb@C@CNT anode, InSb exhibits a very high energy density, InSb exhibits an energy density of 603.5 Wh kg⁻¹ after 100 cycles at 0.2 C rate. Among the three button half-cells, the button half-cell assembled by the bInSb@C@CNT anode shows the highest reversible specific capacity and the best cycle stability, this is due to the particle size of bInSb@C used as the anode active material is small, and the carbon layer coated on the surface of bInSb limits the growth of In whisker-like substances.

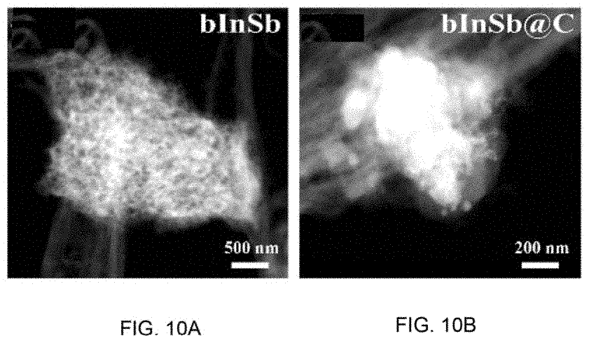

Referring to FIG. 10A and FIG. 10B, the whisker-like substances produced by bInSb during the cycle is in a completely open state, the whisker-like substances produced by bInSb@C during the cycle is completely wrapped inside the carbon layer. Therefore, bInSb@C can inhibit the growth and shedding of In whisker-like substances, thereby preventing the consumption of electrolyte.

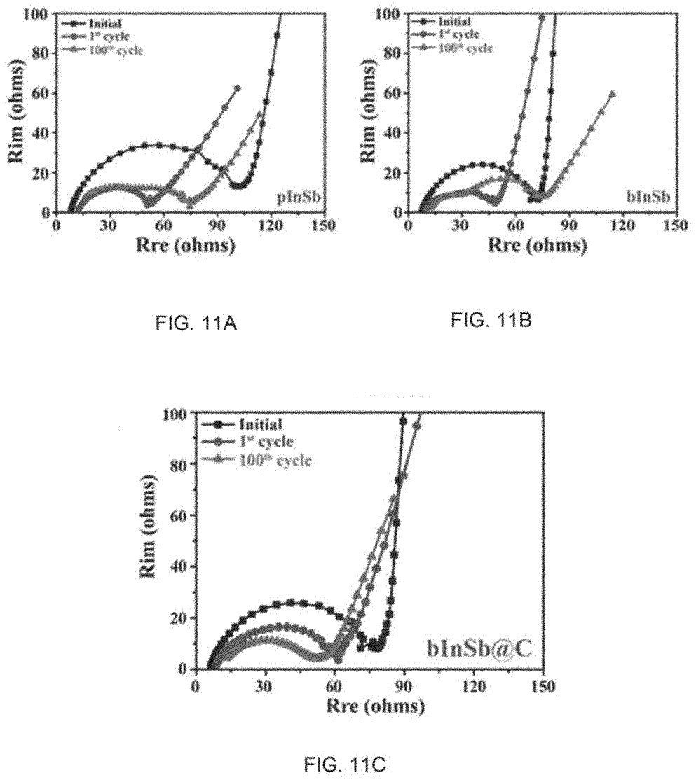

FIG. 11A, FIG. 11B and FIG. 11C are the initial impedance spectrums of the three button half-cells with pInSb@CNT anode, bInSb@CNT anode and bInSb@C@CNT anode respectively, and the impedance spectrums of the three button half-cells after cycling 1 time and 100 times at a rate of 0.2 C. It can be seen that from FIG. 11A-FIG. 11C, the button half-cell assembled with bInSb@C@CNT anode has the best structural stability. Specifically, as the number of cycles increases, a charge transfer resistance of the active material gradually decreases, and an impedance spectrum of the button half-cell assembled with bInSb@C@CNT anode always appears as a semicircle. However, two semicircles are observed in the impedance spectrum of the button half-cell assembled with pInSb@CNT anode after the 100th cycle, and two semicircles are observed in the impedance spectrum of the button half-cell assembled with bInSb@CNT anode after the first cycle. Among the two semicircles, the semicircle in the high frequency region corresponds to the charge transfer impedance of InSb, and the semicircle in the low frequency region corresponds to the charge transfer impedance on the surface of the remaining In/LixIn whiskers. Therefore, a formation of the semicircle in the low frequency region is considered to be a sign of a degree of growth of the In whisker-like substances, which further shows that bInSb@C can limit the growth of the whisker-like substances well.

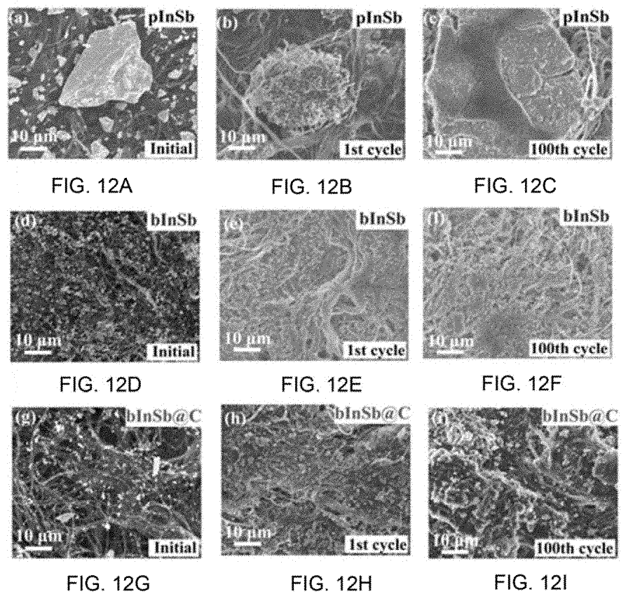

Referring to FIG. 12A-FIG. 12I, it can be seen that from FIG. 12A-FIG. 12I, after the first cycle, there are residual In/LixIn whisker-like substances on the surface of the pInSb particles; this is due to a particle size of the pInSb particle is great. The residual In/LixIn whisker-like substances on the surface of the pInSb verifies a source of the capacity loss and electrolyte consumption. A thick layer of SEI is attached to the surface of pInSb particles after 100 cycles, and a cracking is observed, thereby resulting in deterioration of cycle performance. However, a thickness of SEI of bInSb after 100 cycles is greater than that after the first cycle, the reason is that the particle size of the InSb particle is greatly reduced after ball milling, the bInSb particle can be contact with the conductive network and electrolyte well; but the bInSb is in an open state, the growth of the In whisker-like substances is also strengthened, which leads to an increased electrolyte consumption. The bInSb@C is coated with carbon on the surface of the bInSb, the growth of the In whisker-like substances is effectively suppressed, therefore, the active material particles can still be seen after 100 cycles, and there is little change from the first cycle, which shows that the bInSb@C has the best structural stability.

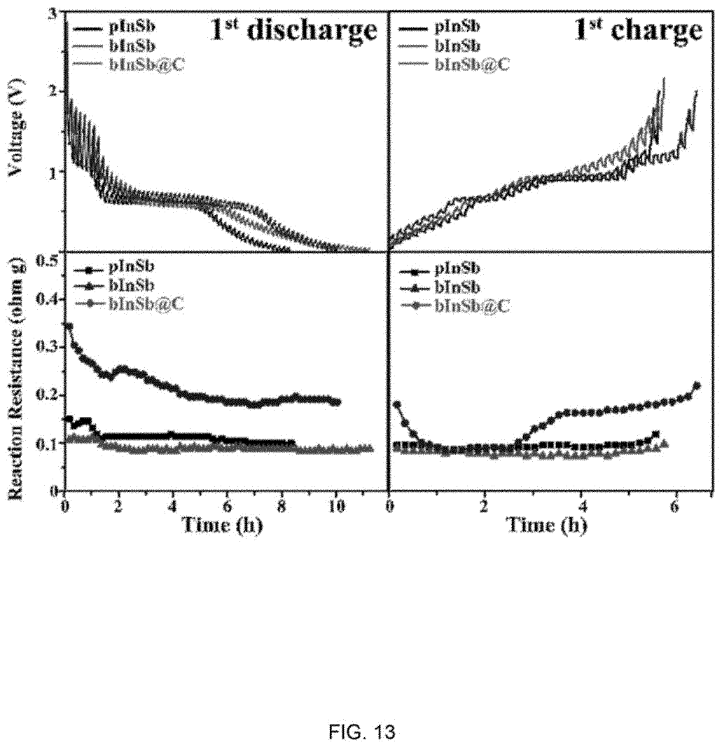

Referring to FIG. 13, it can be seen that from FIG. 13 among the three button half-cells assembled by pInSb@CNT anode, bInSb@CNT anode and bInSb@C@CNT anode, the button half-cell assembled by bInSb@C@CNT anode has the lowest reaction resistance.

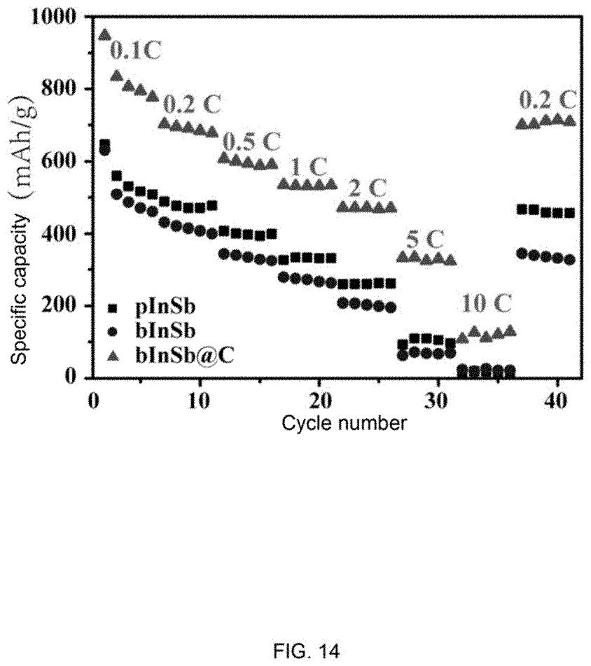

FIG. 14 shows rate characteristics of the three button half-cells assembled with pInSb@CNT anode, bInSb@CNT anode and bInSb@C@CNT anode. It can be seen that the button half-cell assembled by bInSb@C@CNT anode shows the best rate performance, and shows 777.2 mAh g⁻¹, 702.1 mAh g⁻¹, 607.3 mAh g⁻¹, 535.2 mAh g⁻¹, 470.5 mAh g⁻¹, 333.2 mAh g⁻¹, and 108.2 mAh g⁻¹ specific capacity, respectively, at the rate of 0.1 C, 0.2 C, 0.5 C, 1 C, 2 C, 5 C, 10 C. When the current density is switched back to 0.2 C, the specific capacity of the button half-cell assembled with bInSb@C@CNT anode can still be maintain 700.0 mAh g⁻¹. The button half-cell assembled with bInSb@CNT anode shows the worst rate performance. Especially the initial capacity at 0.2 C is 430.8 mAh g⁻¹, but when the current density is switched from 10 C back to 0.2 C, the capacity is only 345.3 mAh g⁻¹, and the capacity recovery rate is only 80.2%. The capacity recovery rate of the button half-cell assembled by bInSb@CNT anode can reach 95.6%. Therefore, the structure of the bInSb@C@CNT anode among the three anodes is the most stable. It is proved that only reducing the particle size aggravates the consumption of electrolyte and the loss of whisker-like substances, thereby resulting a worse rate performance.

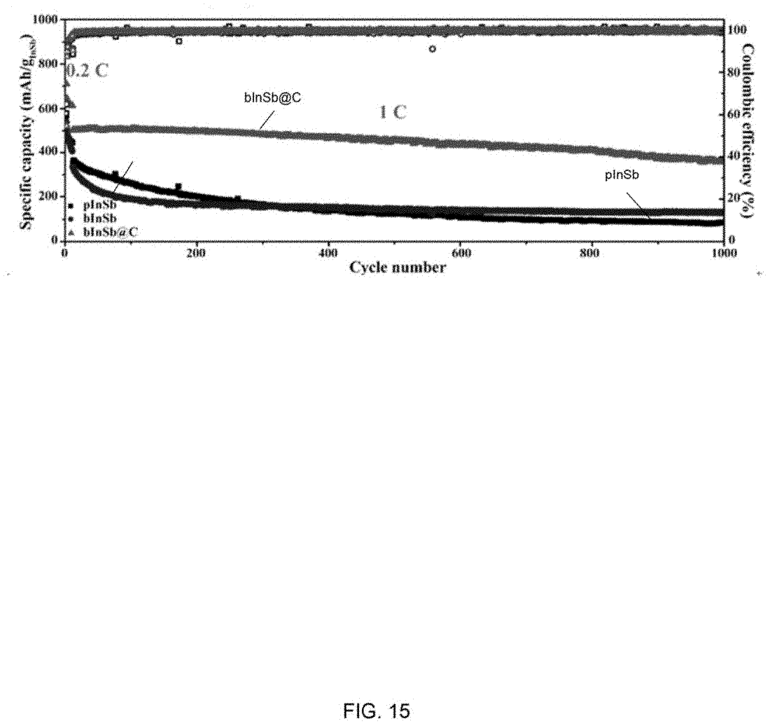

Referring to FIG. 15, FIG. 15 is long-cycle performance of the three button half-cells assembled with pInSb@CNT anode, bInSb@CNT anode and bInSb@C@CNT anode, at a current density of 1 C. The three button half-cells are activated for 10 cycles at a current density of 0.2 C, and then the current density is switched to 1 C. The button half-cell assembled with bInSb@C@CNT anode shows the best long-cycle performance among the three button half-cells. The button half-cell assembled with bInSb@C@CNT anode exhibits a reversible specific capacity of 504 mAh g⁻¹ at a rate of 1 C, and can maintain an specific capacity of 359.4 mAh g⁻¹ after 1000 cycles. A capacity retention rate of the button half-cell assembled with bInSb@C@CNT anode is 71.3%, and an average coulombic efficiency of the button half-cell assembled with bInSb@C@CNT anode is 99.97%. The capacity retention rate and the average coulombic efficiency of the button half-cell assembled with bInSb@C@CNT anode are greater than the capacity retention rate and average coulombic efficiency of the button half-cells assembled with pInSb@CNT anode and bInSb@CNT anode.

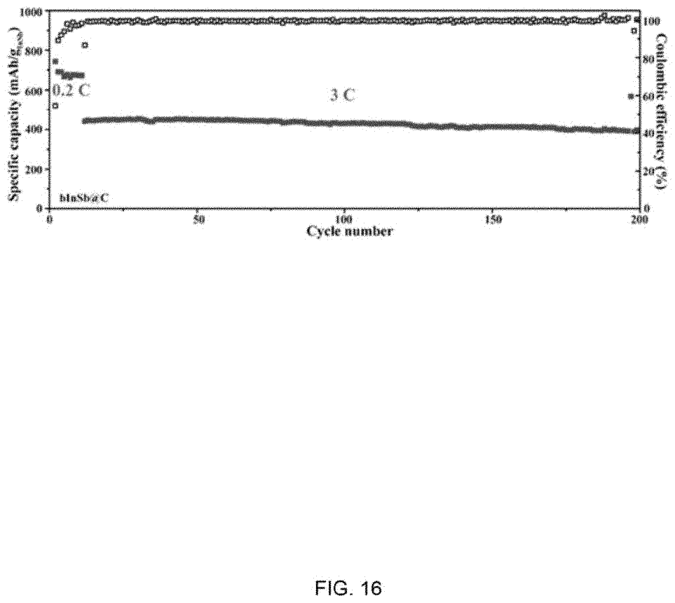

Referring to FIG. 16, after the current density is increased to 3 C, the button half-cell assembled with bInSb@C@CNT anode can still provide an initial capacity of 440.4 mAh g⁻¹, and maintain a reversible specific capacity of 395.4 mAh g⁻¹ after 200 cycles. The capacity retention rate of the button half-cell assembled with bInSb@C@CNT anode is 89.8%, and the average coulombic efficiency of the button half-cell assembled with bInSb@C@CNT anode is 99.95%. FIG. 15 and FIG. 16 further illustrate that the simultaneous application of reducing particle size of the InSb particle and carbon coating can effectively improve the electrochemical performance of lithium-ion battery anodes.

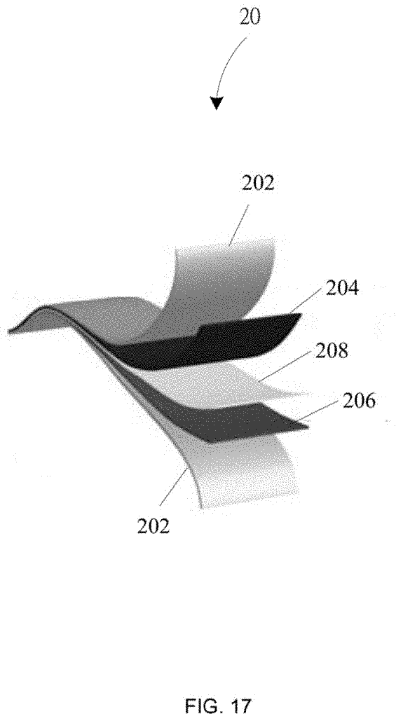

Referring to FIG. 17, a lithium-ion battery 20 of one embodiment is also provided. The lithium-ion battery 20 comprises an external packaging structure 202, an anode 204, a cathode 206, an electrolyte (not shown), and a separator 208. The external packaging structure 202 encapsulates the anode 204, the cathode 206, the electrolyte, and the separator 208. The separator 208 is located between the anode 204 and the cathode 206. The anode 204 comprises an anode active material. The anode active material is the anode active material for lithium-ion battery described as above embodiment. The anode active material comprises a composite material. The composite material is formed by a binary or multi-element metal alloy and a conductive material. The binary or multi-element metal alloy is granular. The conductive material is coated on a surface of a binary or multi-element metal alloy particle to form a continuous conductive material layer, and the binary or multi-element metal alloy particle is completely wrapped by the conductive material. A particle size of the binary or multi-element metal alloy particle is in micron-sized.

The external packaging structure 202, the cathode 206, the electrolyte and the separator 208 can be conventional external packaging structure, cathode, electrolyte and separator of the lithium-ion battery. In one embodiment, a material of each of the external packaging structure 202, the anode 204, the cathode 206, and the separator 208 is a flexible material, the lithium-ion battery 20 is a fully flexible structure, and the lithium-ion battery 20 can be repeatedly bent without affecting the performance of the lithium-ion battery 20.

In one embodiment, an LFP@CNT cathode, a polypropylene (PP) separator and a bInSb@C@CNT anode after pre-lithiation treatment are stacked layer by layer and assembled to a flexible full battery in an aluminum-plastic film packaging material. An electrolyte of the flexible full battery is a solution formed by adding 1 mol/L lithium hexafluorophosphate (LiPF₆) to a non-aqueous solvent of fluoroethylene carbonate (FEC), fluoromethyl ethyl carbonate (FEMC) and (HFE) with a mass ratio of 2:6:2.

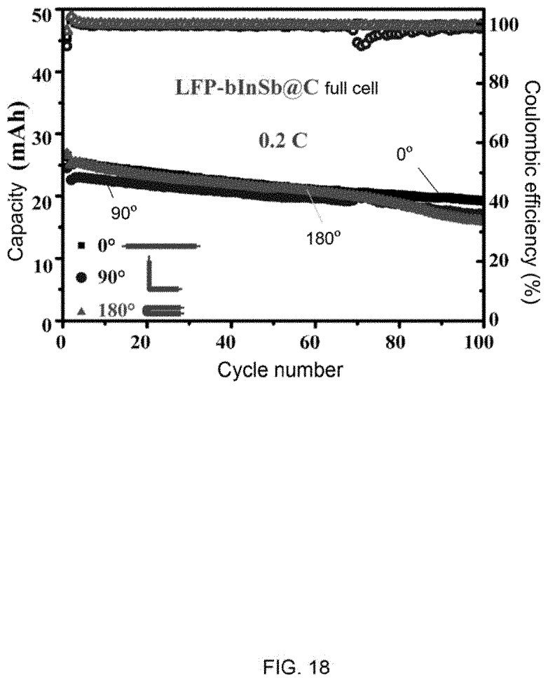

Referring to FIG. 18, at a current density of 0.2 C, the flexible full battery exhibits an initial capacity of 26.4 mAh, and maintains a capacity of 19.2 mAh after 100 cycles. A capacity retention rate of the flexible full battery is 72.7%, and an average coulomb efficiency of the flexible full battery is 99.68%. It can be seen that a cycle stability of the flexible full battery is excellent.

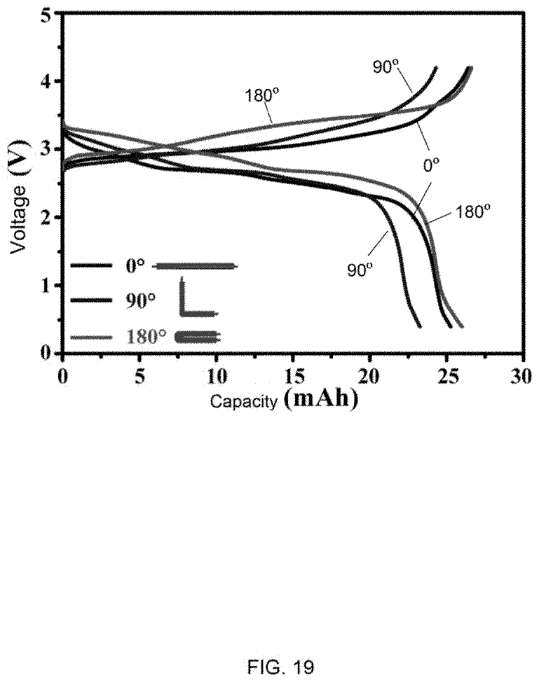

FIG. 19 shows an initial cycle voltage-capacity curve of the flexible full battery under three bending angles. The flexible full battery without bending and bending at 90 degrees has a similar charging and discharging platform, due to bending, a contact tightness of some active substance is decreased, resulting in a slight decrease in capacity. The capacity of the flexible full battery bent at 180 degrees is not only equivalent to that when it is not bent, but also the voltage of the charging and discharging platform is increased. This is due to that the flexible full battery is folded in half and thus a greater pressure is applied on the battery. FIG. 19 shows that bending does not reduce the capacity of the flexible full battery.

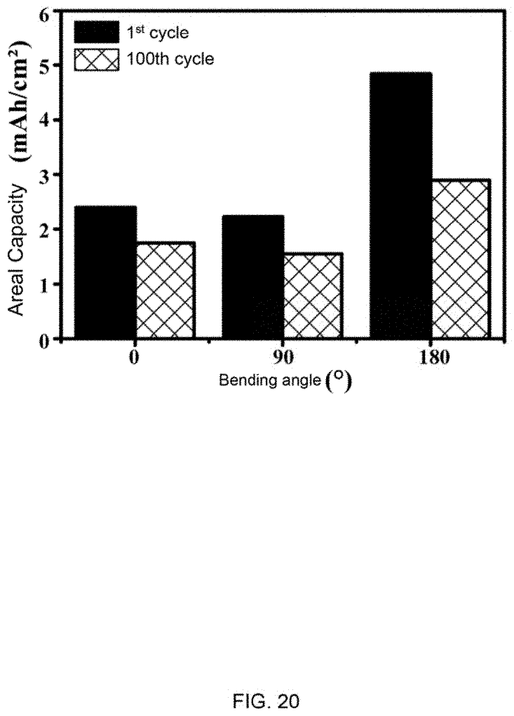

FIG. 20 shows an initial area specific capacity of the flexible full battery under three bending angles and an area specific capacity of the 100th cycle. When the flexible full battery is not bent, the initial area specific capacity of the flexible full battery is 2.4 mAh cm⁻², and the area specific capacity of the 100th cycle is 2.2 mAh cm⁻². When the flexible full battery is bent 90 degrees, the initial area specific capacity of the flexible full battery is 1.7 mAh cm⁻², and the area specific capacity of the 100th cycle is 1.5 mAh cm⁻². When the flexible full battery is bent 180 degrees, since the area of the electrode sheet is reduced by half, the initial area specific capacity of the flexible full battery is 4.8 mAh cm⁻², and the area specific capacity of the 100th cycle is 2.9 mAh cm⁻².

The following specific examples are several specific experimental procedures of the present disclosure.

### Example 1 Method of Making Anode Active Material InSb@C

The initial binary or multi-element metal alloy is InSb powder (Macklin) purchased directly commercially. Dispersing the initial binary or multi-element metal alloy in ethanol; and ball milling the initial binary or multi-element metal alloy in a ball mill at a speed of 400 r/min for 12 hours; and then recovering the powder by centrifugation, and grinding the powder with a mortar for 10 minutes to obtain the InSb particles with a particle size of 2 micrometers. Further mixing the particles and sucrose in a mass ratio of 1:1 to obtained a mixture; adding deionized water into the mixture and performing ultrasonic treatment to form a dispersion; and then drying all moisture of the dispersion at 80° C., to obtained a InSb precursor coated with sucrose; and finally, heating the InSb precursor to 450° C. under argon atmosphere and keeping for 2 h, to obtain InSb@C powder.

### Example 2 Method of Making Anode for Flexible Lithium-Ion Battery

Mixing 30 mg of InSb@C powder in Example 1, 10 mg of super-aligned carbon nanotube arrays and 60 mL of ethanol to obtain a mixture, and then ultrasonically dispersing the mixture to obtain a dispersion; vacuum filtrating the dispersion using an organic filter membrane (38 mm in diameter) to obtain a membrane; drying the ethanol in the filter membrane to obtain a carbon nanotube paper carrying the anode active material; and cutting the carbon nanotube paper carrying the anode active material into a discs with 10 mm diameter by a ring knife, and the discs with 10 mm diameter is the anode for flexible lithium-ion battery. A surface loading of InSb in the anode for flexible lithium-ion battery is about 1.5 mg cm⁻² to 2 mg cm⁻².

### Example 3 Method for Assembling Button Half-Cells

The pInSb@CNT anode, bInSb@CNT anode and bInSb@C@CNT anode are respectively used as positive electrodes, a polypropylene film is used as diaphragm, a lithium foil is used as a negative electrode, a solution formed by adding 1 mol/L lithium hexafluorophosphate (LiPF₆) to a non-aqueous solvent of fluoroethylene carbonate (FEC), fluoromethyl ethyl carbonate (FEMC) and (HFE) with a mass ratio of 2:6:2 is used as an electrolyte, stainless steel gaskets and springs are also used, and CR2025 battery shell is used to assemble three button half-cells. The assembly process of the three button half-cells is carried out in an argon glove box.

### Example 4 Method for Assembling an Flexible Full Battery

20 mg of super-aligned carbon nanotube array (SACNT) and 180 mg of lithium iron phosphate (LFP) are added to ethanol and ultrasonically disperse to obtain a dispersion; and vacuum filtering the dispersion to obtain a LFP@CNT cathode. Mixing 30 mg SACNT and 100 mg bInSb@C to obtain a bInSb@C@CNT anode with matching capacity. Stacking the LFP@CNT cathode, the PP diaphragm and the bInSb@C@CNT anode in order and installing in the aluminum plastic film, and injecting electrolyte into the aluminum plastic film and vacuum hot pressing. The electrolyte is a solution formed by adding 1 mol/L lithium hexafluorophosphate (LiPF6) to a non-aqueous solvent of fluoroethylene carbonate (FEC), fluoromethyl ethyl carbonate (FEMC) and (HFE) with a mass ratio of 2:6:2. Ay process of assembling an flexible full battery is carried out in an argon glove box.

The anode active material anode active material for lithium-ion battery provided by the present disclosure combines the particle size of the binary or multi-element metal alloy and the surface-coated conductive material. The particle size of the binary or multi-element metal alloy particles is in the micron-sized, the anode active material is in full contact with the conductive network and the electrolyte, therefore, the anode active material has high active material utilization rate and high initial capacity. Since the conductive material is coated on the surface of binary or multi-element metal alloy particles, the growth, cracking and shedding of whisker-like substances on the surface of binary or multi-element metal alloy particles during the lithium-ion cycle are restricted. Therefore, the electrolyte consumption and irreversible capacity are avoided. The cycle stability of lithium-ion batteries is further improved. Moreover, the volume and area expansion of the anode of the lithium-ion battery can be restricted by restricting the growth of the whisker-like substance, and the volume expansion rate and the area expansion rate can be reduced. The binary or multi-element alloys in the lithium-ion battery anode are completely reversible during the cycle, and thus the reversible capacity and cycle stability of the lithium-ion battery anode are greatly improved; and the lithium-ion battery anode can be cycled in the state of fully intercalating lithium to exert a maximum capacity. Further, as anode materials for lithium-ion batteries, the binary or multi-element metal alloys have a relatively low volume expansion rate compared to elemental metals.

It is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

Depending on the embodiment, certain of the steps of a method described may be removed, others may be added, and the sequence of steps may be altered. The description and the claims drawn to a method may include some indication in reference to certain steps. However, the indication used is only to be viewed for identification purposes and not as a suggestion as to an order for the steps.

What is claimed is:

1. An anode active material for lithium-ion battery, comprising:
a composite material, wherein the composite material comprises:
a plurality of binary or multi-element metal alloy particles, wherein the plurality of binary or multi-element metal alloy particles are in micron-size, and the binary or multi-element metal alloy has a lattice reversibility; and
a conductive material coated on surfaces of the plurality of binary or multi-element metal alloy particles, wherein each of the plurality of binary or multi-element metal alloy particles is completely wrapped by the conductive material.

2. The anode active material of claim 1, wherein the binary or multi-element metal alloy comprises at least two metal elements among Zn, Al, Ga, In, Ge, Sn, Sb, Bi, Ag, Au, Mg, and Ca.

3. The anode active material of claim 1, wherein the binary or multi-element metal alloy has a crystal structure with a reversibility of lithium-ion deintercalation.

4. The anode active material of claim 3, wherein the binary or multi-element metal alloy has a zinc blende crystal structure.

5. The anode active material of claim 4, wherein the binary or multi-element metal alloy is an indium antimonide (InSb) alloy with the zinc blende crystal structure.

6. The anode active material of claim 1, wherein the particle sizes of the plurality of binary or multi-element metal alloy particles are in a range from 1 micrometer to 10 micrometers.

7. The anode active material of claim 1, wherein a thickness of the conductive material layer ranges from 10 nanometers to 50 nanometers.

8. The anode active material of claim 1, wherein the conductive material is a carbon material or a conductive polymer.

9. A method for making an anode active material for lithium-ion battery comprising:
step S1, providing an initial binary or multi-element metal alloy, ball milling the initial binary or multi-element metal alloy to obtain a plurality of binary or multi-element metal alloy particles, and a particle size of each of the plurality of binary or multi-element metal alloy particles is in micron-sized; and
step S2, coating a conductive material on surfaces of the plurality of binary or multi-element metal alloy particles, and each of the plurality of binary or multi-element metal alloy particles is completely wrapped by the conductive material.

10. The method of claim 9, wherein the plurality of binary or multi-element metal alloy particles have a lattice reversibility.

11. The method of claim 10, wherein each of the plurality of binary or multi-element metal alloy particles has a zinc blende crystal structure.

12. The method of claim 11, wherein the plurality of binary or multi-element metal alloy particles are indium antimonide (InSb) alloy with the zinc blende crystal structure.

13. The method of claim 12, wherein the conductive material is coated on the InSb by a liquid coating method using a sucrose solution comprising:
mixing the InSb and sucrose in a mass ratio of 1:1 to 1:3 to obtain a mixture;
adding deionized water into the mixture and performing ultrasonic treatment to form a dispersion;
drying all moisture of the dispersion at 80-100° C., to obtain a InSb precursor coated with sucrose; and
heating the InSb precursor to 400-500° C. under argon atmosphere and keeping for 2-3 h, to obtain InSb@C powder.

14. A lithium-ion battery comprising:
an anode comprising an anode active material layer and a current collector, wherein the anode active material layer is supported by the current collector, and the anode active material layer comprises a composite material comprising:
a plurality of binary or multi-element metal alloy particles, wherein the plurality of binary or multi-element metal alloy particles are in micron-size, and the binary or multi-element metal alloy has a lattice reversibility; and
a conductive material coated on surfaces of the plurality of binary or multi-element metal alloy particles, wherein each of the plurality of binary or multi-element metal alloy particles is completely wrapped by the conductive material; and
a cathode;
an electrolyte;
a separator located between the anode and the cathode; and
an external packaging structure encapsulating the anode, the cathode, the electrolyte, and the separator.

15. The lithium-ion battery of claim 14, wherein the binary or multi-element metal alloy is a crystal structure with a reversibility of lithium-ion deintercalation.

16. The lithium-ion battery of claim 15, wherein the binary or multi-element metal alloy is a zinc blende crystal structure.

17. The lithium-ion battery of claim 16, wherein the binary or multi-element metal alloy is an indium antimonide (InSb) alloy with the zinc blende crystal structure.

18. The lithium-ion battery of claim 14, wherein the particle sizes of the plurality of binary or multi-element metal alloy particles are in a range from 1 micrometer to 10 micrometers.

19. The lithium-ion battery of claim 14, wherein a thickness of the conductive material layer ranges from 10 nanometers to 50 nanometers.

20. The lithium-ion battery of claim 14, wherein a material of each of the external packaging structure, the anode, the cathode, and the separator is a flexible material, and the lithium-ion battery is a flexible structure.
